(19) United States
(12) Patent Application Publication
(10) Pub. No.: US 2016/0344144 A1
(43) Pub. Date: Nov. 24, 2016

(54) POWER CABLE CONNECTOR ASSEMBLY

(71) Applicant: FOXCONN INTERCONNECT TECHNOLOGY LIMITED, Grand Cayman (KY)

(72) Inventors: JERRY WU, Irvine, CA (US); JUN CHEN, Kunshan (CN); ZHENG-RONG ZHU, Kunshan (CN)

(21) Appl. No.: 15/159,837

(22) Filed: May 20, 2016

(30) Foreign Application Priority Data
May 22, 2015 (CN) 201510262922.4

(51) Int. Cl. H01R 13/66; H01R 13/42

(52) U.S. Cl. CPC H01R 13/6683; H01R 13/42

(57) ABSTRACT

A power cable connector assembly includes: an electrical connector including an insulative housing, a number of contacts retained in the insulative housing, and an outer case enclosing the insulative housing; a cable electrically connecting with the electrical connector, the cable including a number of core wires connected with corresponding contacts and a number of control wires; and a sensor enclosed by the outer case, the sensor including a number of conductive wires connected with corresponding control wires and a mounting portion, the mounting portion having a through hole for fixing the sensor to the insulative housing.

### BACKGROUND OF THE INVENTION

1. Field of the Invention

The present invention relates to a power cable connector, and more particularly to a power cable connector having a temperature control function.

2. Description of the Related Art

U.S. Patent Application Publication No. 2016/0104978, issued on Apr. 14, 2016, discloses an electrical apparatus comprising an electrically insulating body housing at least two electrical connection elements and a temperature sensor.

The temperature sensor is received in a thermally conductive and electrically insulating support element which is separate from and mounted inside the body.

U.S. Patent Application Publication No. 2016/0104988, issued on Apr. 14, 2016, discloses a power plug having a temperature sensor element positioned therein. The temperature sensor element may have a temperature sensor pin. When the temperature sensed by the temperature sensor element is higher than the first threshold value, the temperature element produces a first sense signal through the signal processing circuit. When the temperature sensed by the first threshold value, the temperature sensor element may transmit another sense signal.

A power cable connector assembly having an improved sensor mounting structure is desired.

### BRIEF SUMMARY OF THE INVENTION

An object of the present invention is to provide a power cable connector assembly having an improved sensor mounting structure.

In order to achieve above-mentioned object, a power cable connector assembly comprises: an electrical connector including an insulative housing, a plurality of contacts retained in the insulative housing, and an outer case enclosing the insulative housing; a cable electrically connecting with the electrical connector, the cable including a plurality of core wires connected with corresponding contacts and a plurality of control wires; and a sensor enclosed by the outer case, the sensor including a plurality of conductive wires connected with corresponding control wires and a mounting portion, the mounting portion having a through hole for fixing the sensor to the insulative housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view showing a power cable connector assembly in accordance with the present invention;

FIG. 2 is a perspective view showing the power cable connector assembly shown in FIG. 1, in accordance with a first embodiment, omitting an outer case;

FIG. 3 is a partially exploded view of the power cable connector assembly shown in FIG. 2;

FIG. 4 is a further exploded view of the power cable connector assembly shown in FIG. 3;

FIG. 5 is an exploded view of the power cable connector assembly shown in FIG. 2;

FIG. 6 is a perspective view showing the power cable connector assembly shown in FIG. 1, in accordance with a second embodiment, omitting an outer case;

FIG. 7 is a partially exploded view of the power cable connector assembly shown in FIG. 6;

FIG. 8 is a further exploded view of the power cable connector assembly shown in FIG. 7;

FIG. 9 is a perspective view showing the power cable connector assembly shown in FIG. 1, in accordance with a third embodiment, omitting an outer case;

FIG. 10 is a partially exploded view of the power cable connector assembly shown in FIG. 9;

FIG. 11 is a perspective view showing the power cable connector assembly shown in FIG. 1, in accordance with a fourth embodiment, omitting an outer case; and

FIG. 12 is a partially exploded view of the power cable connector assembly shown in FIG. 11.

### DESCRIPTION OF PREFERRED EMBODIMENT OF THE INVENTION

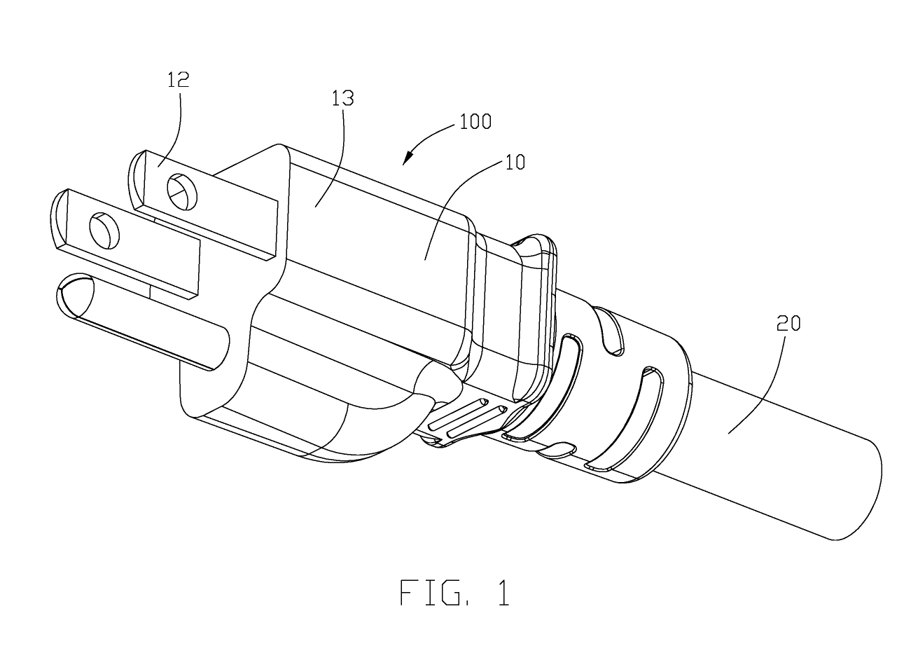

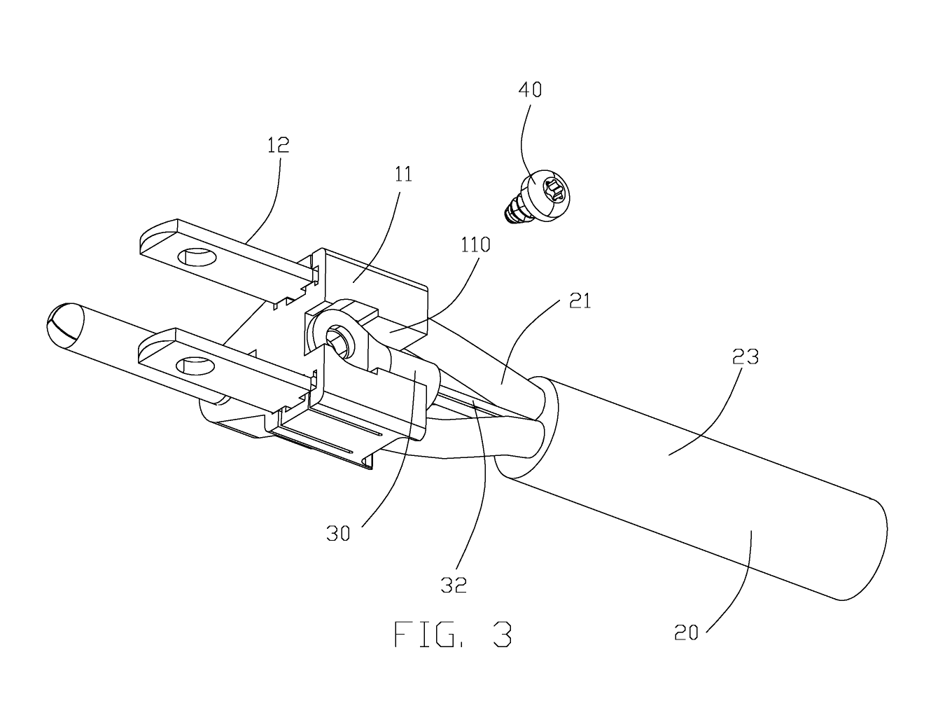

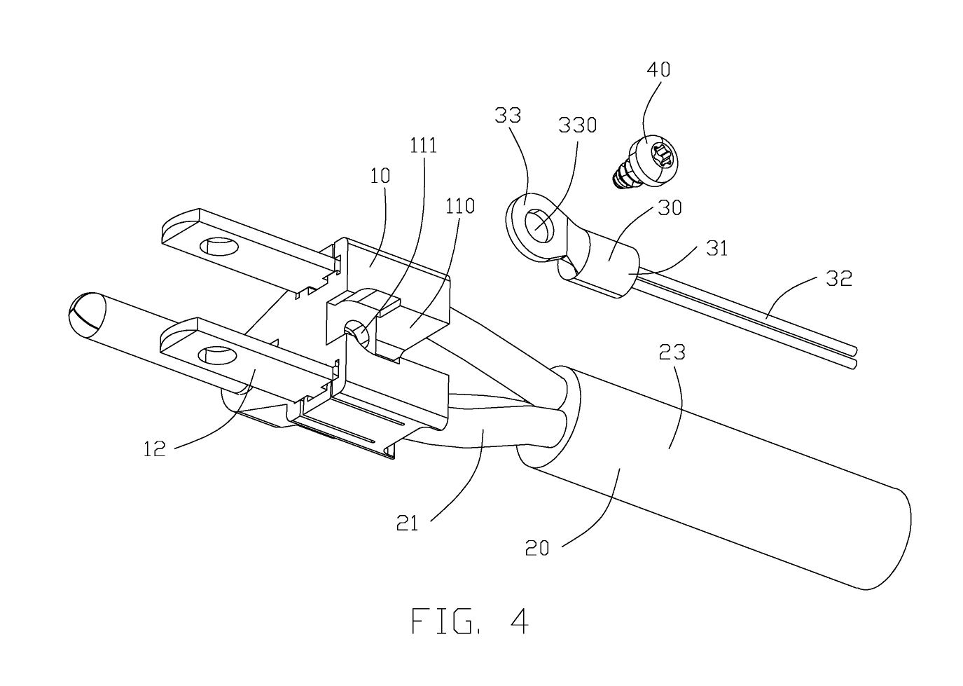

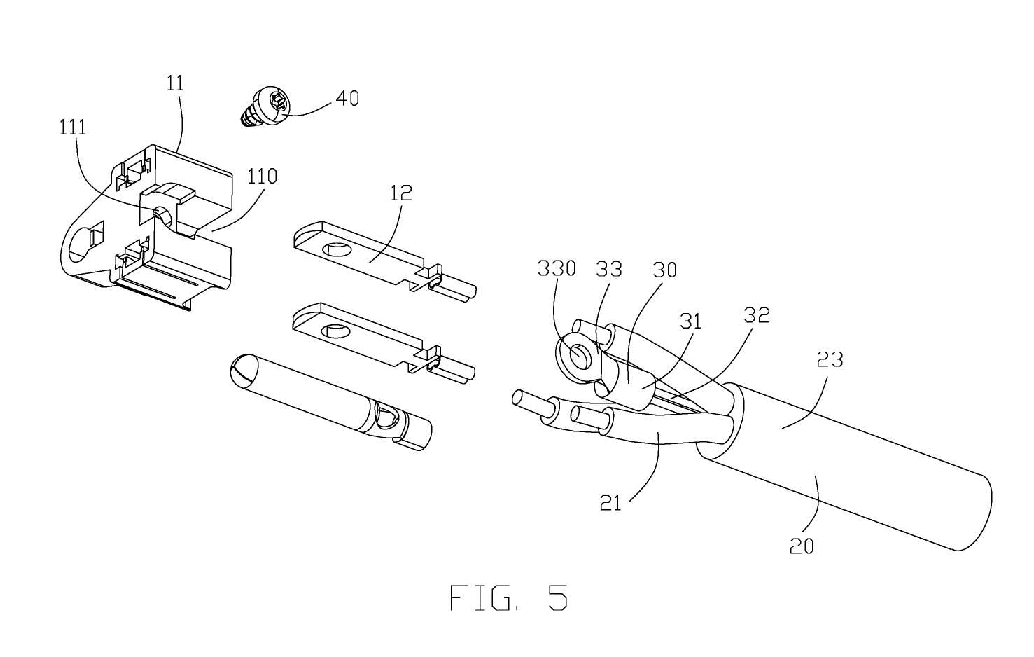

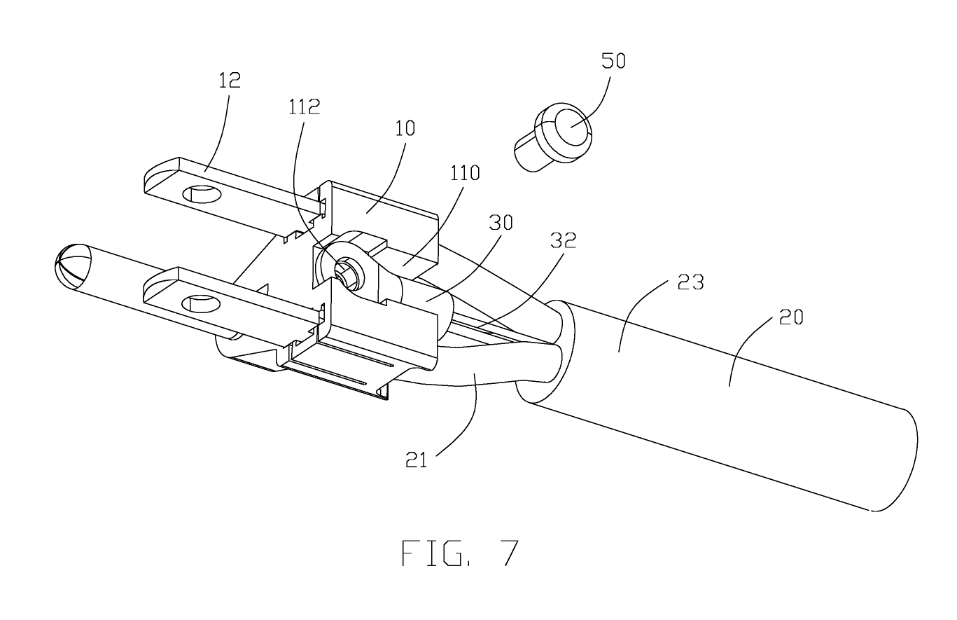

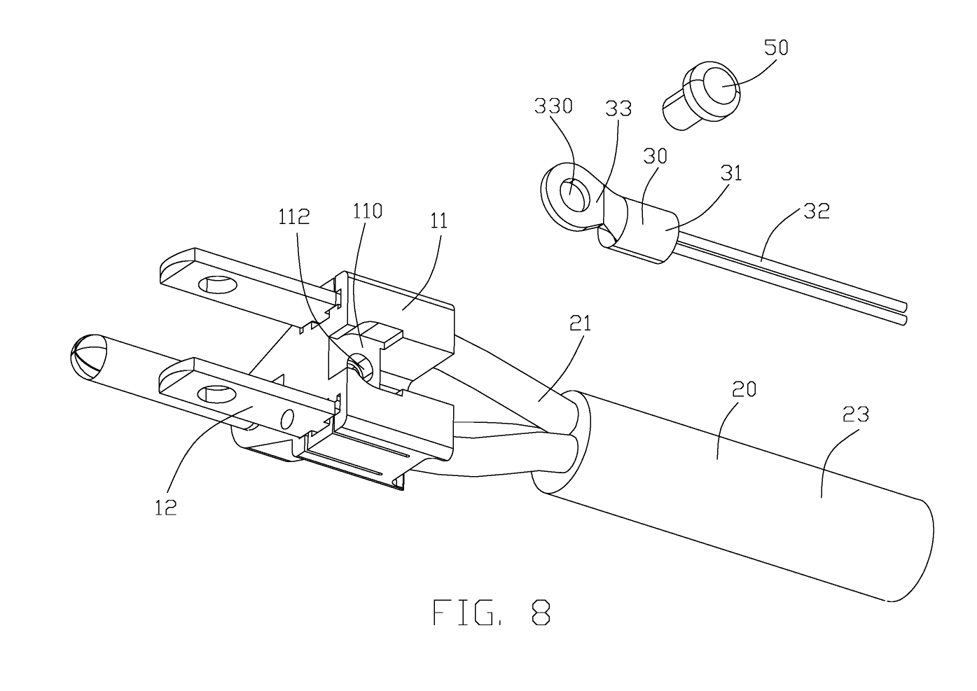

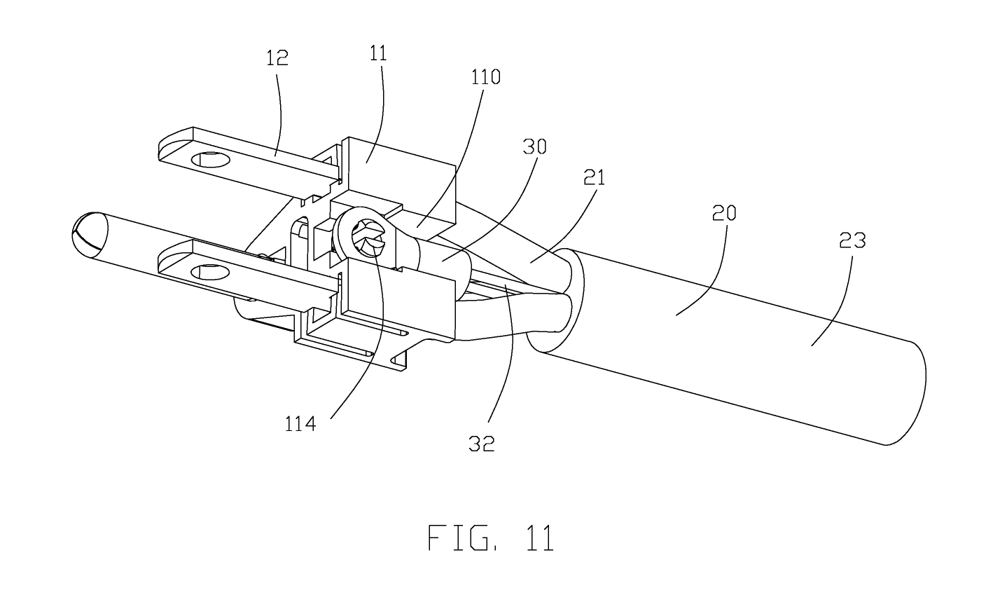

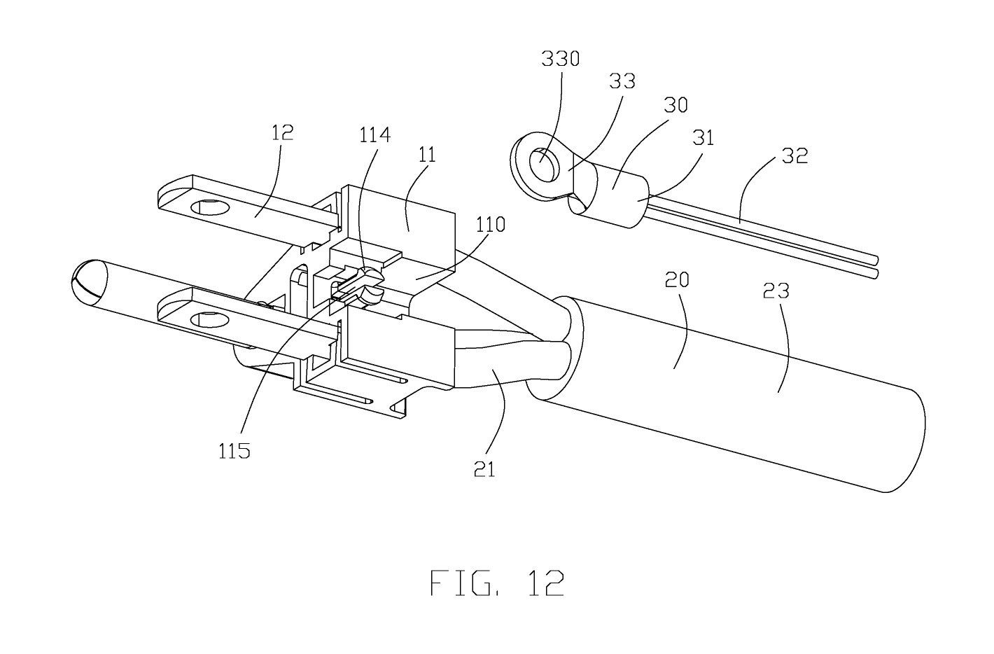

Reference will now be made to the drawing figures to describe a preferred embodiment of the present invention in detail. Referring to FIGS. 1-12, the power cable connector assembly 100 according to the present invention includes an electrical connector 10, a cable 20 connecting with the electrical connector 10, and a sensor 30. When the sensor 30 detects the heat exceeds a set value, the power cable connector assembly will drop-out current or drop-out voltage.

The power cable connector assembly includes an insulative housing 11, a plurality of contacts 12 retained in the insulative housing 11 and an outer case 13 enclosing the insulative housing 11. The insulative housing 11 defines a depression portion 110 thereon. In the present embodiment, the number of the contacts 12 is three, and two of them are of sheet shape, and another is of columnar shape. In other embodiment, the number and the shape of contacts 12 are not limited. Users can set the appropriate number and shape according to the specific requirements and applications. The contacts 12 extend to expose to the outer case 13, for being inserted into a mating connector. The material of the outer case 13 is insulation materials. The outer case 13 can be integrally molded in the outside of the insulative housing 11, or be mounted to the insulative housing 11 after being manufactured separately.

The cable 20 includes a plurality of core wires 21 electrically connected with the corresponding contacts 12, a controlling wires (not shown) electrically connected with the sensor 30, and an insulative layer covering the core wires 21 and control wire.

The sensor 30 is enclosed in the outer case 13 and mounted on the insulative housing 11. The sensor 30 includes a main body 31, a pair of conductive wires 32 rearwardly extending from an end of the main body 31, and a mounting portion 33 forwardly extending from another end of the main body 31. The pair of conductive wire 32 is connected to the control wires. The thickness of the mounting portion 33 is smaller than the thickness of the main body 31. The mounting portion 33 defines a through hole 330. The sensor 30 is received in the depression portion 110 of the insulative housing 11, but not exceeding the surface of the insulative housing 11. When the power cable connector assembly 100 is charging, the resistance of the sensor 30 resistance will increase with the increase of heat, the power cable connector assembly will drop-out electric current or drop-out voltage until the resistance value exceeds a predetermined value.

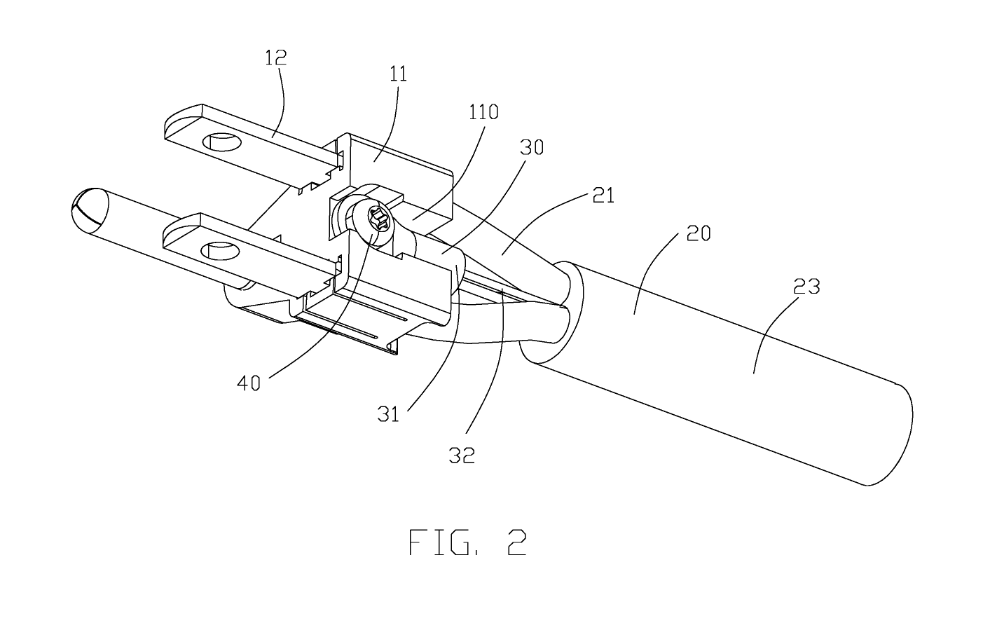

Referring to FIGS. 2-5, the power cable connector assembly 100 in accordance with a first embodiment further includes a screw 40. The depression portion 110 of the insulative housing 11 defines a screw hole 111 corresponding to the screw 40 therein. The sensor 30 is fixed on the insulative housing 11 by locking the screw 40 into the screw hole 111 through the through hole 330.

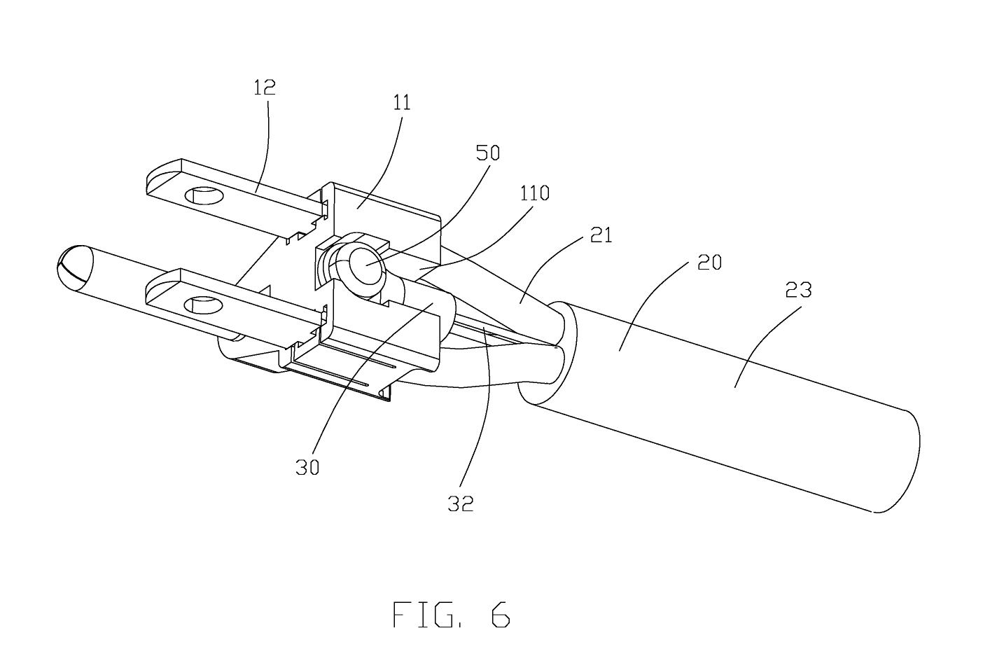

Referring to FIGS. 6-8, the power cable connector assembly 100 in accordance with a second embodiment further includes a fitting pin 50. The depression portion 110 of the insulative housing 11 defines a mounting hole 112 corresponding to the fitting pin 50 therein. The sensor 30 is fixed on the insulative housing 11 by locking the fitting pin 50 into the mounting hole 112 through the through hole 330.

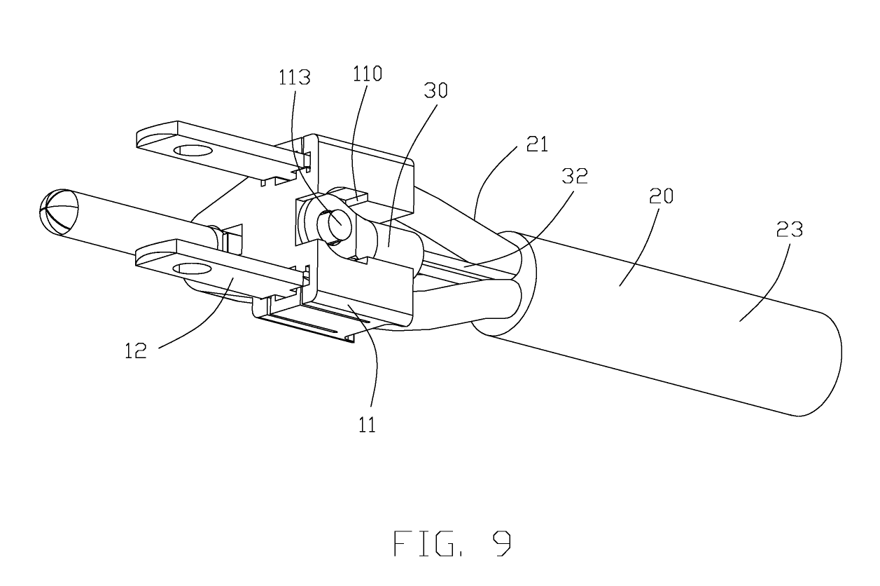

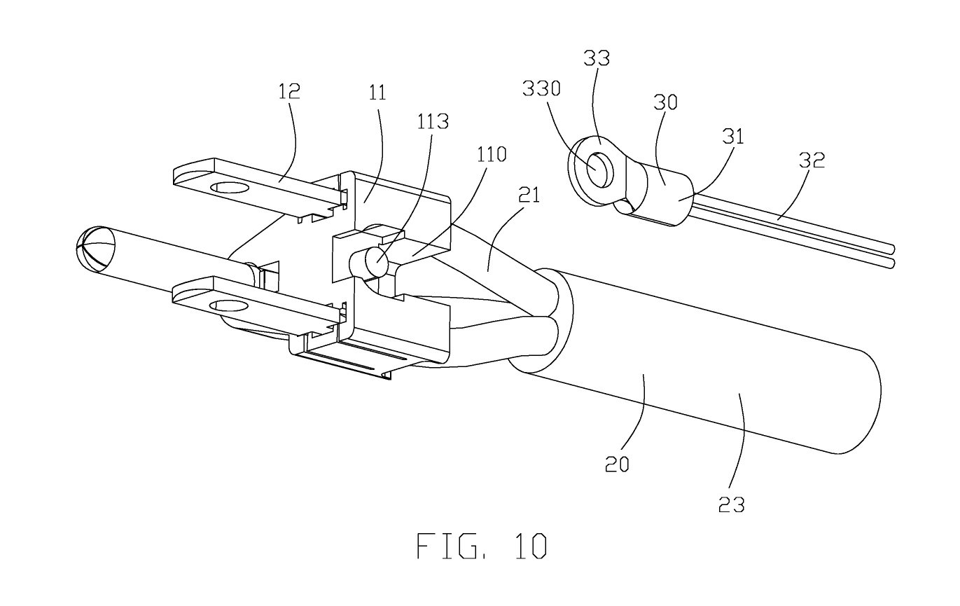

Referring to FIGS. 9-10, the power cable connector assembly 100 in accordance with a third embodiment is shown. In the present embodiment, the depression portion 110 of the insulative housing 11 defines a mounting post 113 thereon. The sensor 30 is fixed on the insulative housing 11 by fixing the mounting post 113 in the through hole 330 using hot melt method.

Referring again to FIGS. 9-10, the power cable connector assembly 100 in accordance with a third embodiment is shown. In the present embodiment, the depression portion 110 of the insulative housing 11 defines a locking post 114 thereon. The locking post 114 defines a slit portion 115 therein, to enhance the elasticity of the locking post 114. The sensor 30 is fixed on the insulative housing 11 by the locking post 114 being locked in the through hole 330.

The power cable connector assembly 100 accordance with the present invention detects the temperature by the sensor 30, thus has a high sensitivity and reliability.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. A power cable connector assembly comprising:
an electrical connector including an insulative housing, a plurality of contacts retained in the insulative housing, and an outer case enclosing the insulative housing;
a cable electrically connecting with the electrical connector, the cable including a plurality of core wires connected with corresponding contacts; and
a sensor enclosed by the outer case, the sensor including a plurality of conductive wires and a mounting portion, the mounting portion fixing the sensor to the insulative housing; wherein
electrical transmission through said core wires is controlled by said sensor.

2. The power cable connector assembly as described in claim 1, wherein said mounting portion forms a through hole through which the sensor is fixed to the housing.

3. The power cable connector assembly as described in claim 2, wherein the sensor includes a main body and said plurality of conductive wires rearwardly extend from the main body, and the mounting portion forwardly extends from the main body.

4. The power cable connector assembly as described in claim 2, further including a screw passing through the through hole of the sensor and locked to the insulative housing.

5. The power cable connector assembly as described in claim 2, wherein the insulative housing defines a mounting post passing through the through hole of the sensor and fixed in the through hole by hot melting.

6. The power cable connector assembly as described in claim 2, further including a fitting pin passing through the through hole of the sensor and interferentially fitted with the insulative housing.

7. The power cable connector assembly as described in claim 2, wherein the insulative housing defines a locking post passing through the through hole of the sensor and locked with the sensor.

8. The power cable connector assembly as described in claim 2, wherein the insulative housing has a depression portion receiving the sensor.

9. The power cable connector assembly as described in claim 8, wherein the sensor is fixed in the depression portion below the surface of the insulating housing.

10. A power cable connector assembly comprising:
an insulative housing;
a pair of contacts retained by the housing with contacting sections exposed outside of the housing;
a grounding contact retained around the housing with a contacting portion exposed outside of the housing, the contacting sections of said pair of contacts and the contacting portion of the grounding contact commonly forming a triangular arrangement viewed along a front-to-back direction;
a cable connected to a rear side of the housing and including a plurality of core wires respectively connected to the corresponding contacts and grounding contact;
a heat sensor located adjacent to said pair of contacts connected with corresponding conductive wires embedded within the cable.

11. The power cable connector assembly as claimed in claim 10, further including an outer case enclosing said housing and said sensor for veiling the sensor.

12. The power cable connector assembly as claimed in claim 11, wherein the sensor is attached to the housing before the outer case is applied thereon.

13. The power cable connector assembly as claimed in claim 11, wherein the sensor includes a main body from which the conductive wires rearwardly extend, and a mounting portion through which the sensor is attached to the housing before the outer case is applied upon both the housing and the sensor.

14. The power cable connector assembly as claimed in claim 11, wherein said mounting portion forms a through hole attached to the housing via a pin like piece.

15. The power cable connector assembly as claimed in claim 11, wherein the sensor is located between the pair or contacts in a transverse direction perpendicular to said front-to-back direction.

16. The power cable connector assembly as claimed in claim 11, wherein said sensor is opposite to the grounding contact in a vertical direction perpendicular to both said front-to-back direction and said transverse direction.

17. A method of controlling power transmission, comprising steps of:
providing an insulative housing with a pair of contacts retained therein with corresponding contacting section exposed outside of the housing;
providing a grounding contact retained around the housing with a corresponding contacting portion exposed outside of the housing;
providing a cable with a plurality of core wires respectively connected to the pair of contacts and the grounding contact; and
providing a heat sensor around the pair of contacts respectively connected to corresponding conductive wires; wherein
controlling electronic transmission via said contacts by means of said heat sensor through said conductive wires.

18. The method as claimed in claim 17, wherein the core wires and the conductive wires are both embedded within the cable.

19. The method as claimed in claim 17, further including a step of forming a recess in the housing between the contacting sections of said pair of contacts and disposing said sensor in said recess.

20. The method as claimed in claim 17, further including a step of overmolding an outer case upon the housing and the sensor with contacting sections of the pair of contacts and the contacting portion of the grounding contact are exposed to an exterior.
